(19) United States
(12) Patent Application Publication
(10) Pub. No.: US 2014/0028811 A1
(43) Pub. Date: Jan. 30, 2014

(54) METHOD FOR VIEWING MULTIPLE VIDEO STREAMS SIMULTANEOUSLY FROM A SINGLE DISPLAY SOURCE

(71) Applicant: Mark Ebersole, Campbell, CA (US)

(72) Inventor: Mark Ebersole, Campbell, CA (US)

(73) Assignee: NVIDIA CORPORATION, Santa Clara, CA (US)

(21) Appl. No.: 13/557,091

(22) Filed: Jul. 24, 2012

(51) Int. Cl. H04N 13/04

(52) U.S. Cl. CPC H04N 13/04
USPC 348/54

(57) ABSTRACT

A method and controller are presented which associate subsets of frames from an input video data stream and maps each subset to its respective viewer which video stream is then displayed in full screen mode. The method and controller further synchronize each viewer's optical discriminators with the display screen in a manner such that each viewer only views their mapped content on a display screen in full screen mode. In this fashion, multiple viewers may perceive independent content on a display screen in full screen mode.

### BACKGROUND

The ability to view multiple streams of data on a single display enables a viewer the ability to, among other things, visualize content from different perspectives or allows different viewers to view different content while looking at a single display. The current approaches to viewing multiple video streams on a single display, however, limits viewer enjoyment in certain instances. For example, viewers may wish to watch different movies or shows and, simultaneously, enjoy the full features of a given display, e.g. dimensions and/or resolution of a television or monitor, while viewing their respective content. Current approaches require the display source to be partitioned in order to allow viewers to view their respective content in a multi-display environment, thus, sacrificing viewer enjoyment of display source features.

This issue is especially problematic within the video game industry. In a multiplayer video game, more than one person can play the same game in the same physical location at the same time, while looking at the same display screen. Currently, games designed for multiple players partition a display source into sections in an attempt to create isolated, mini-environments for each user. Under this approach, players are precluded from maintaining competitive balance in the form of limiting what other opponents may see or hear within the game environment due to the inherent split screen nature of how the content is displayed. Also, by partitioning the screen, the player's experience is limited because each player's view is substantially reduced compared to the overall screen dimensions.

### SUMMARY OF THE INVENTION

Accordingly, a need exists to allow multiple viewers to view multiple video streams at the same time at full screen resolution and dimension, from a single display source. Utilizing 3D technology, methods of the embodiments of the present invention provide a level of flexibility in the field of home entertainment that will enhance viewer experience.

In one embodiment, the present invention is directed toward a display method of allowing a number of viewers to view different content displayed on a single display screen, in full screen mode. In one embodiment, the content may be in the form of video data. In another embodiment, the content may be in the form of 3D video data. The method includes associating subsets from a plurality of frames of content to respective different viewers to produce a plurality of associated viewer sets.

The method also includes storing the associated viewer sets in a frame memory buffer. Also, the method includes displaying the associated viewer sets on the single display screen, in full screen mode, where each viewer has associated therewith a respective optical discriminator of a plurality of optical discriminators. In one embodiment, the optical discriminators of the display method may be each coupled with their own respective audio output device which further receives and renders audio associated with the associated viewer set. Also, the optical discriminators of the display method may be connected through a wired connection to a controller. Also, the optical discriminators may be connected through a wireless connection to a controller. Furthermore, the optical discriminators may incorporate active shutter 3D system technology.

Furthermore, the method includes synchronizing each optical discriminator with the displaying, where the synchronizing allows each viewer to perceive only an associated viewer set on the single display screen. The synchronization step may include detecting the display attributes of a display screen. Also, the synchronization step may include detecting a number of optical discriminators from a plurality of optical discriminators. Also, the synchronization step may include determining the synchronization rate of the optical discriminators based on the display attributes and the number of optical discriminators detected. Furthermore, the synchronization step may include transmitting a periodic synchronization signal based on the synchronization rate of each optical discriminator.

In another embodiment, the present invention is directed toward a display method of allowing a plurality of viewers to view different content displayed on a single display screen. In one embodiment, the content may be in the form of video data. In another embodiment, the content may be in the form of 3D video data. The method includes identifying a plurality of frames of content from a grouped frame set to produce a plurality of grouped frame subsets.

The method also includes associating each grouped frame subset from a plurality of grouped frame subsets to a different optical discriminator, of a number of optical discriminators, producing a plurality of associated viewer sets. In one embodiment, the optical discriminators of the display method may be each coupled with their own respective audio output device which further receives audio associated with the associated viewer set and renders available audio output. Also, the optical discriminators of the display method may be connected through a wired connection. Also, the optical discriminators may be connected through a wireless connection. Furthermore, the optical discriminators may incorporate active shutter 3D system technology. The method also includes storing the associated viewer sets in a frame memory buffer. Also, the method includes displaying the number of associated viewer sets on a single display source in full screen mode.

Furthermore, the method includes synchronizing each optical discriminator with the displaying process, in which the synchronizing allows a respective viewer of an associated optical discriminator to perceive only an associated viewer set on the display screen. The synchronization step may include detecting the display attributes of a display screen. Also, the synchronization step may include detecting a plurality of optical discriminators from a plurality of optical discriminators. Also, the synchronization step may include determining the synchronization rate based on the display attributes and the number of optical discriminators detected. Furthermore, the synchronization step may include transmitting a periodic synchronization signal based on the synchronization rate of each optical discriminator. In one embodiment, the synchronization step may include synchronization signals which are infrared signals.

In yet another embodiment, the present invention is directed toward a display system. The display system includes a controller which is operable to communicate with a number of optical discriminators and a display screen system. The controller includes an identifying module for identifying a plurality of frames of content from a grouped frame set to produce a plurality of grouped frame subsets.

The controller also includes an associating module for associating subsets from a plurality of frames of content to respective different viewers of the plurality of viewers to produce a plurality of associated viewer sets, where each viewer has associated therewith a respective optical discriminator of a plurality of optical discriminators. In one embodiment, the optical discriminators of the display system may be each coupled with their own respective audio receiving and rendering device which further receives and renders audio associated with the associated viewer set. Also, the optical discriminators of the display system may be connected through a wired connection. Also, the optical discriminators may be connected through a wireless connection. Additionally, the optical discriminators may incorporate active shutter 3D system technology. Furthermore, the controller includes a storage module for storing the associated viewer sets in a frame memory buffer.

The controller also includes a synchronization module for generating synchronization signals for synchronizing each optical discriminator with the display system, where the synchronizing allows each viewer to perceive only an associated viewer set on a single display screen. The display system also includes a display screen system which includes a single display screen as well as a displaying module for displaying the number of associated viewer sets on said single display screen in full screen mode.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure

FIG. 1 depicts an exemplary display system upon which embodiments of the present invention may be implemented.

FIG. 2A is a diagram that depicts a storage process in accordance with embodiments of the present invention.

FIG. 2B is a diagram that depicts another storage process in accordance with embodiments of the present invention.

FIG. 2C is a diagram that depicts yet another storage process in accordance with embodiments of the present invention.

FIG. 3A is a diagram that depicts a method of displaying video data streams in accordance with embodiments of the present invention.

FIG. 3B is a diagram that depicts another method of displaying video data streams in accordance with embodiments of the present invention.

FIG. 3C is a diagram that provides an exemplary depiction of various viewer perspectives of the display screen in accordance with 3D embodiments of the present invention.

FIG. 4A depicts a timing diagram of the display screen in accordance with embodiments of the present invention.

FIG. 4B depicts a timing diagram in accordance with embodiments of the present invention.

FIG. 4C depicts a timing diagram in accordance with embodiments of the present invention.

FIG. 5 depicts a flowchart of a process for displaying each viewer's representation of video content, in accordance with embodiments of the present invention.

FIG. 6 depicts an exemplary optical discriminator in accordance with embodiments of the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

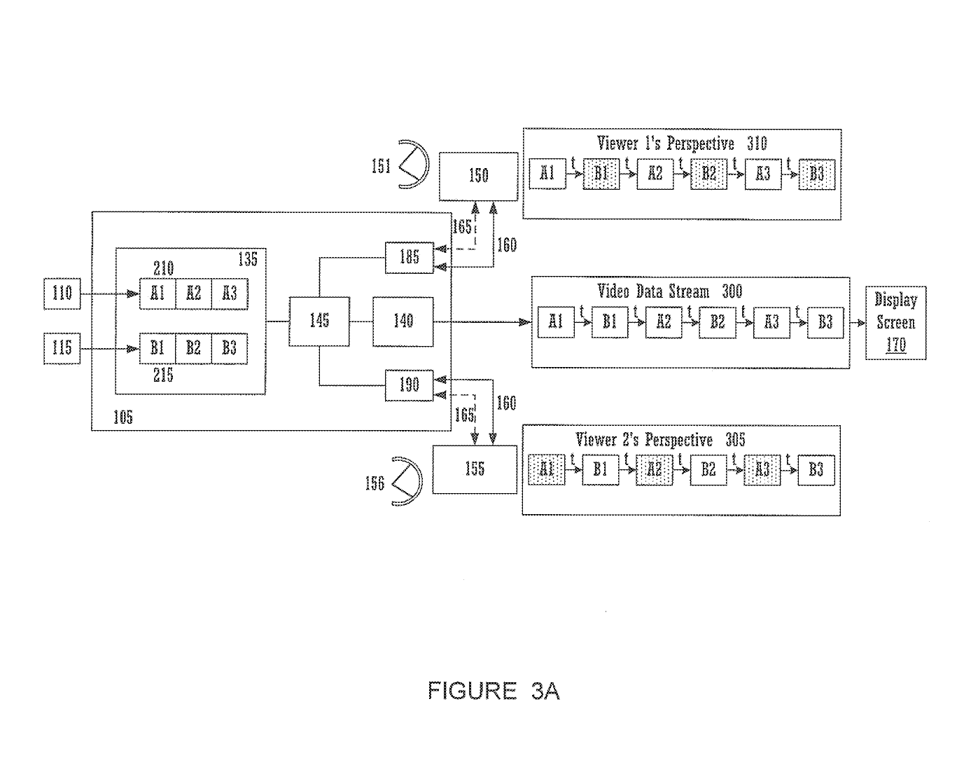

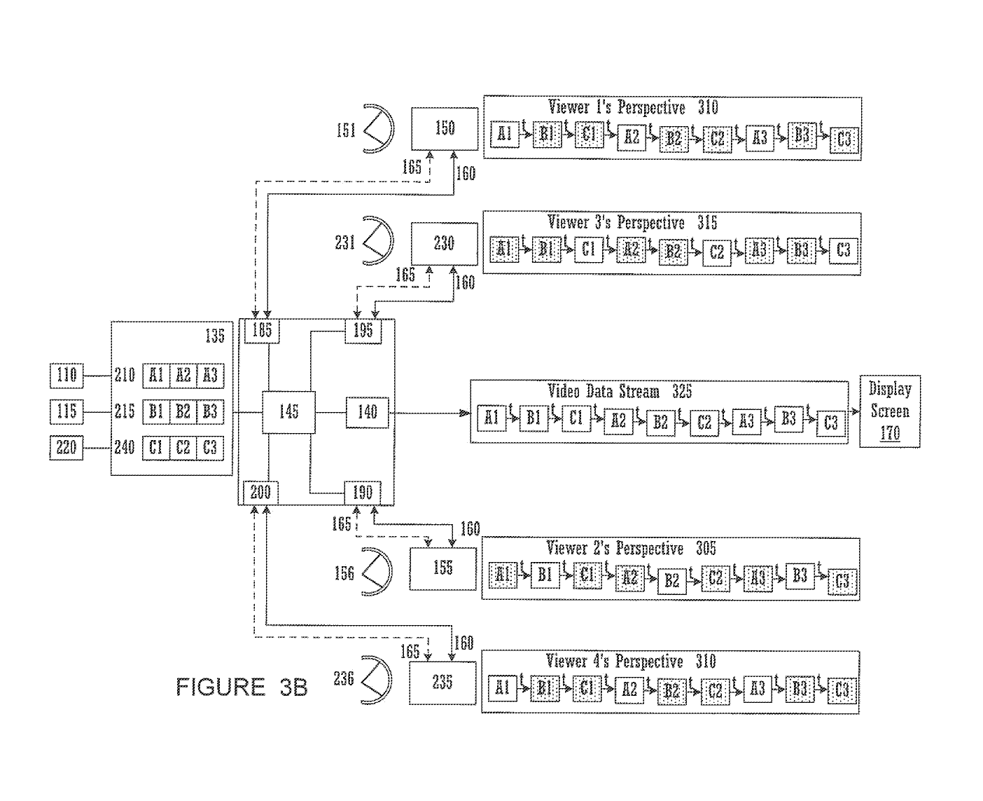

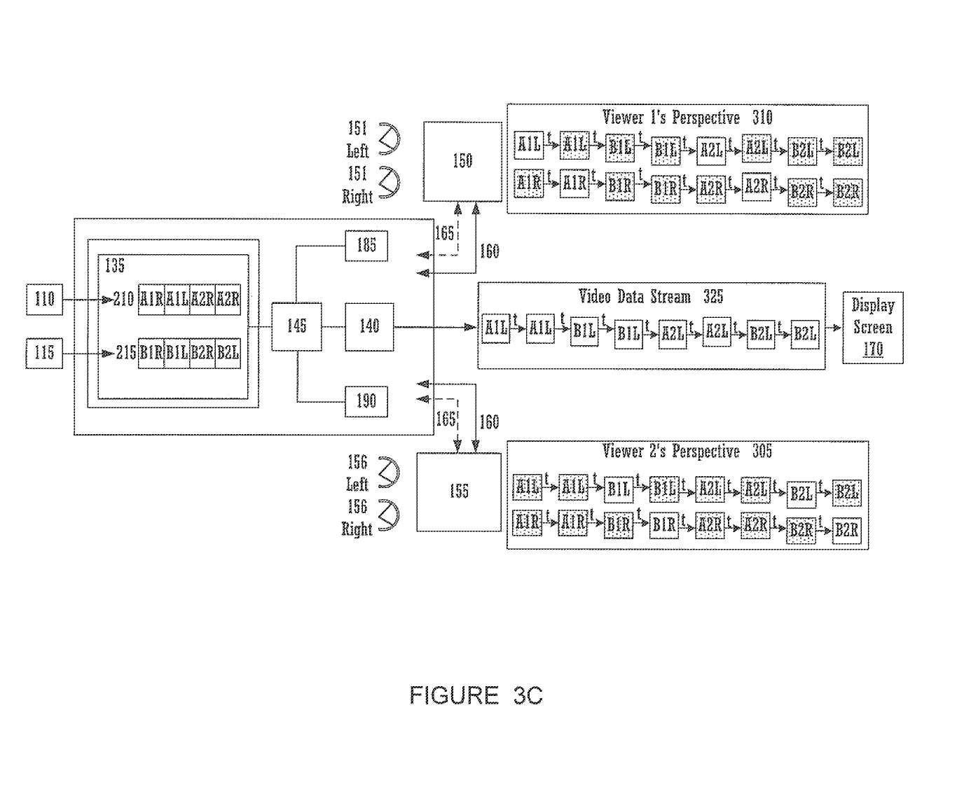

Portions of the detailed description that follow are presented and discussed in terms of a process. Although operations and sequencing thereof are disclosed in a figure herein (e.g., FIGS. 3A, 3B, 3C, 4A, 4B, 4C and 5) describing the operations of this process, such operations and sequencing are exemplary. Embodiments are well suited to performing various other operations or variations of the operations recited in the flowchart of the figure herein, and in a sequence other than that depicted and described herein.

As used in this application the terms controller, module, system, and the like are intended to refer to a computer-related entity, specifically, either hardware, firmware, a combination of hardware and software, software, or software in execution. For example, a module can be, but is not limited to being, a process running on a processor, an integrated circuit, an object, an executable, a thread of execution, a program, and or a computer. By way of illustration, both an application running on a computing device and the computing device can be a module. One or more modules can reside within a process and/or thread of execution, and a component can be localized on one computer and/or distributed between two or more computers. In addition, these modules can be executed from various computer readable media having various data structures stored thereon.

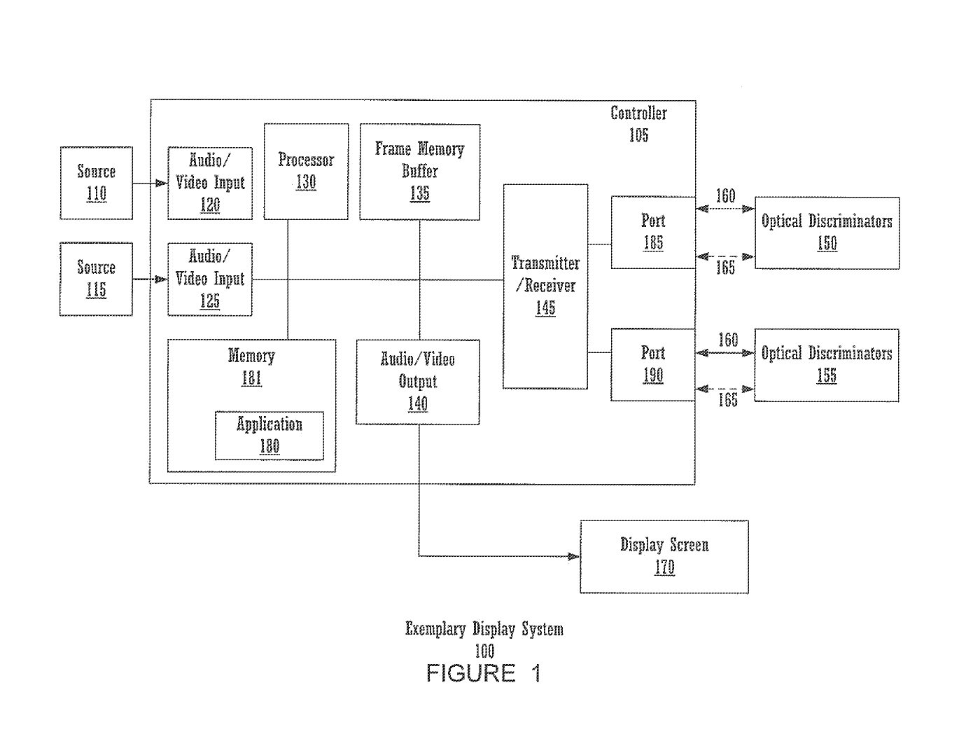

As presented in FIG. 1, an exemplary display system 100 upon which embodiments of the present invention may be implemented is depicted. In an embodiment, display system 100 may be implemented within a television, monitor, gaming console or any electronic device capable of receiving audio/video input and transmitting audio/video output to a display screen.

Controller 105 receives a first video data stream from source 110 and a second video data stream from source 115 through audio/video input 120 and audio/video input 125 respectively. Video data streams may consist of frames relating to a particular content, such as a video game, movie, live television feed, etc. Furthermore, video data streams may include 3D data which may include frames specifically designed for each eye of an intended viewer. Embodiments of the present invention may detect the attributes of the display screen, such as the dimensions and/or refresh rate of a display source to determine a synchronization rate and synchronize lenses of optical discriminators accordingly to accommodate such 3D data.

Although controller 105 depicts two audio/video inputs, the embodiments of the present invention may support multiple audio/video inputs. Video data streams may be sourced from a variety of potential resources (e.g. DVD player, video game console, live television feed, etc.). Sources may be representative of any electronic device capable of producing video content and audio content.

Processor 130 processes instructions from application 180 located in memory 181 to read data received from audio/video inputs 120 and 125 and to store the data in frame memory buffer 135 for further processing by transmitter/receiver 145 via internal bus 175. Furthermore, processor 130 also processes instructions from application 180 for transmitter/receiver 145 to read data that is stored in frame memory buffer 135 and to deliver data to audio/video output 140 via internal bus 175 for display on display screen 170. The data received from frame memory buffer 135 may be displayed one frame at a time on display screen 170 as a time interleaved video data stream comprised of frames from both source 110 and source 115.

Transmitter/receiver 145 facilitates the synchronization process between the controller 105 and optical discriminators 150 and 155 in which optical discriminator 150 and 155 are synchronized to view only the frames of a specific video data stream, such as source 110 or source 115 in FIG. 1. Transmitter/receiver 145 has the capabilities to send discrete blanking channel signals 160 and audio signals 165 to optical discriminators 150 and 155 through ports 185 and 190 respectively. Ports may associate optical discriminators and the sources providing the content through logical connections. Furthermore, ports may be either hardware or software in form.

Although two video sources and two optical discriminators are shown, embodiments of the present invention fully support 1:N mapping configurations, where N number of optical discriminators may be associated to N number of sources. Furthermore, such synchronization and audio communication may be either a wired or a wireless communication. Although FIG. 1 displays one transmitter/receiver 145, embodiments of the present invention support multiple transmitter/receivers for the purposes of sending blanking channels signals or audio signals to multiple optical discriminators.

Blanking channel signals 160 may contain instructions to prevent either optical discriminator 150 or 155 from viewing frames displayed on display screen 170. For example, if a viewer using optical discriminator 150 is configured to view the content stored in source 110, transmitter/receiver 145 may send a blanking channel signal 160 to obstruct the view of any optical discriminator not mapped to source 110, such as optical discriminator 155, for each frame of source 110 displayed on display screen 170. Furthermore, when a frame not belonging to source 110 is displayed on display screen 170, transmitter/receiver 145 may send a blanking channel signal 160 to obstruct the view of optical discriminator 150.

Methods of obstruction may include a modified form of synchronization incorporated in active shutter 3D technology, which presents images intended for one eye by blocking the other eye and then alternating the presentation using a different image intended for the previously unblocked eye. For example, images to be viewed by the left eye are presented by blocking the right eye, which is then followed by presenting images to the right eye by blocking the left eye. This form of display makes use of liquid crystal shutter glass lenses that may be instructed to darken through infrared signal, radio frequency signals, Bluetooth, optical transmitter signals, etc. This form of synchronization is modified by embodiments of the present invention by sending a signal to darken both lenses simultaneously of the optical discriminators when presented with a frame that is not to be viewed by those optical discriminators. Furthermore, this form of synchronization may be utilized to present 3D images on various types of displays, such as CRT, plasma, LCD, etc.

Furthermore, this exemplary form of synchronization creates virtual, isolated environments for each viewer on one display screen, in full screen mode, in which each viewer receives video and audio attributed to a specific video data stream that may not be shared with those not similarly synchronized to perceive such an environment. The methods of obstructing a viewer from viewing a frame may not be limited to use of the modified active shutter 3D system technology discussed and may utilize an alternative method of obstructing the view of an unauthorized viewer. In an exemplary case, optical discriminators 150 and 155 may be in the form of eye-glasses worn by the viewers.

Discrete audio signals 165 may be delivered to audio receiving and rendering devices associated with or integrated within optical discriminators 150 and 155. Audio signals 165 may be delivered contemporaneously with video from source 110 or source 115 to provide a viewer with sound that corresponds to the video delivered. Each audio signal 165 may include different audio, e.g. audio intended for only its associated viewer. Furthermore, the optical discriminator 150 or 155 may be configured to associate with either ports 185 or 190. Although FIG. 1 illustrates two sources, two optical discriminators, and two ports, embodiments of the present invention may support multiple sources, optical discriminators and ports other than those depicted in FIG. 1. Furthermore, the delivery of audio signals occur concurrently with the process of displaying the interleaved video data stream comprising of frames from both source 110 and source 115 on display screen 170.

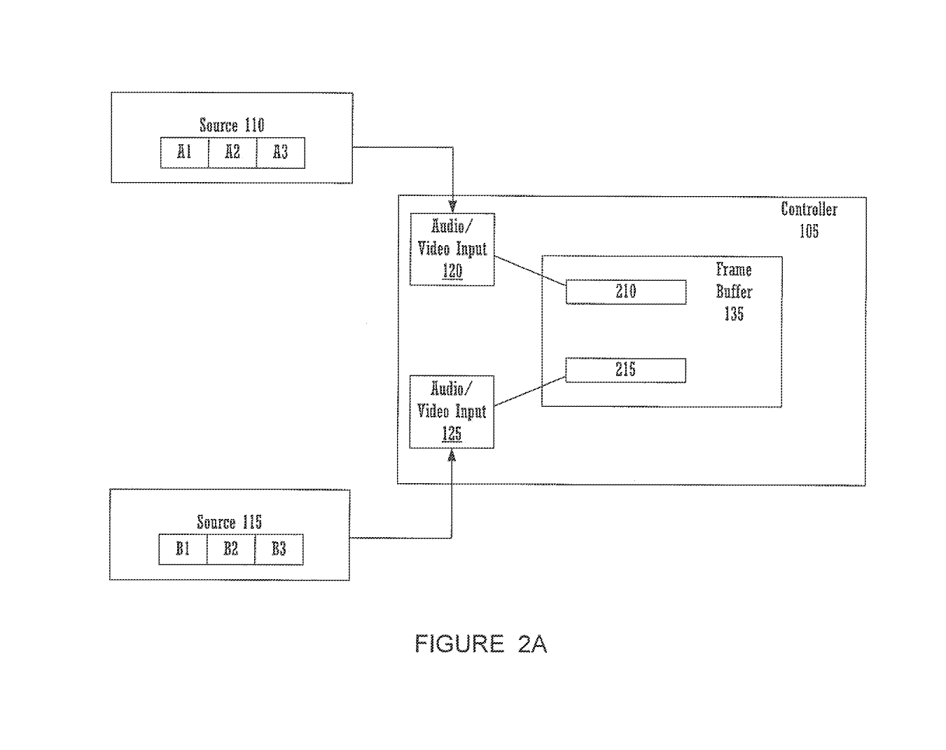

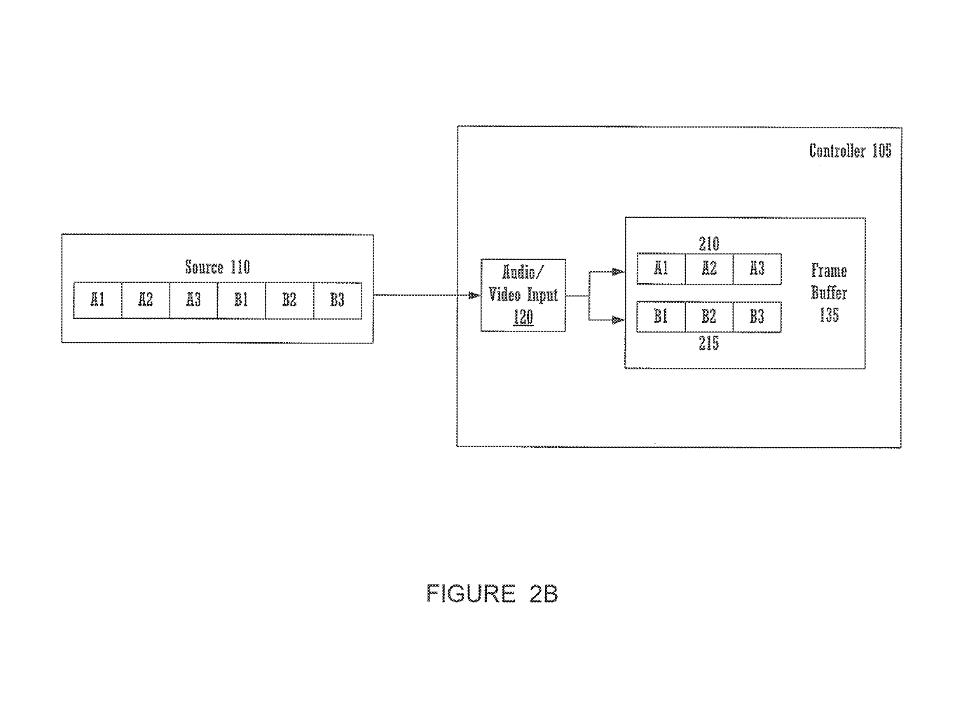

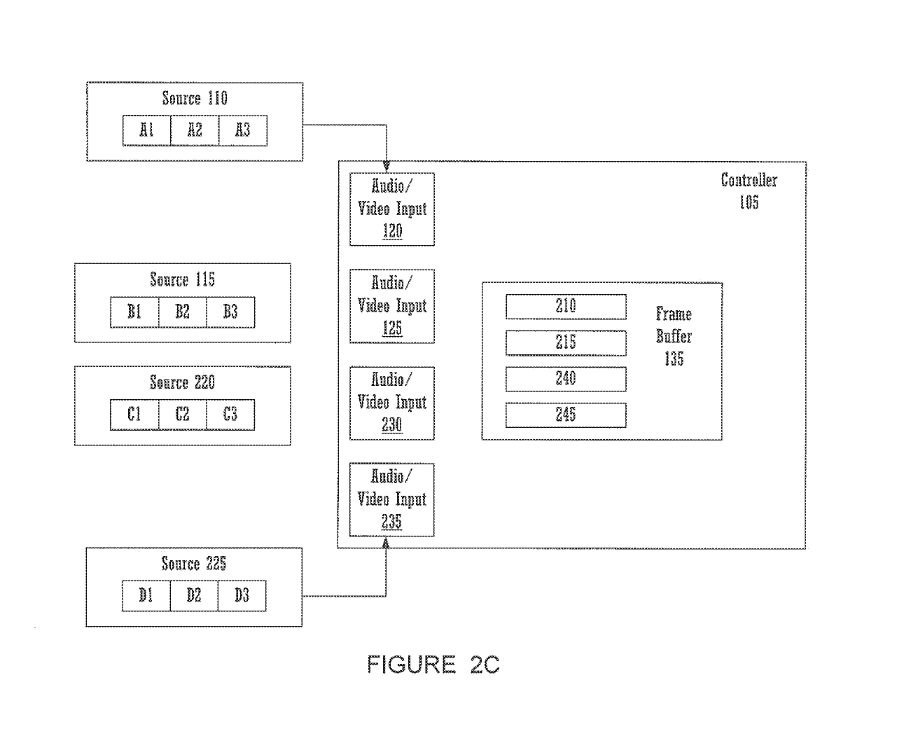

FIG. 2A is an exemplary depiction of the storage process of two video data streams from two sources. Frames “A1,” “A2,” and “A3” represent a first video data stream from source 110, while frames “B1,” “B2,” and “B3” represent a second video data stream from source 115. In one embodiment of the present invention, the data from source 110 is received through audio/video input 120 of controller 105 and stored in frame memory buffer 135. Similarly, the data from source 115 is received through audio/video input 125 of controller 105 and stored in frame memory buffer 135.

An embodiment of the present invention may provide partitioned storage buffers within frame memory 135 such that the first video data stream is allocated a storage buffer separate from the second data stream as depicted by the allocated buffer 210 for the first video data stream and allocated buffer 215 for the second video data stream. Partitioning the storage of the first and second video data streams may allow processor 130 to processes instructions from application 180 to display one frame at a time on display screen 170 as an interleaved video data stream comprised of frames from both source 110 and source 115.

FIG. 2B is another exemplary depiction of the storage process of two video data streams from one source. Frames “A1,” “A2,” and “A3” represent a first video data stream from source 110, while frames “B1,” “B2,” and “B3” represent a second video data stream from the same source 110. In one embodiment of the present invention, the data from source 110 is received through audio/video input 120, which may be able to perform an inverse multiplexing operation on the incoming data and produce two video data streams which may be stored in allocated buffer 210 and allocated buffer 215. This configuration may allow a two-player video game that is sourced from one video game console to provide each player with his own separate representation of the game.

FIG. 2C is yet another exemplary depiction of the storage process of multiple video data streams from multiple sources, e.g. four different sources. In addition to a first video data stream from source 110 and a second video data stream from source 115, another embodiment of the present invention may support a third data stream consisting of frames “C1,” “C2,” and “C3” from source 220 which is received through audio/video input 230 of controller 105 and a fourth data stream consisting of frames “D1,” “D2,” and “D3” from source 225 which is received through audio/video input 235 of controller 105. The embodiment may partition storage buffers within frame memory 135 such that the first, second, third, and fourth video data streams are each allocated a storage buffer separate from each other, as indicated by the presence of 240 for the third video data stream and allocated buffer 245 for the fourth video data stream.

FIG. 3A provides an exemplary depiction of the display of the interleaved video data stream comprised of frames from both source 110 and source 115 as well as the concurrent execution of the discrimination synchronization process by transmitter/receiver 145. Port 185 has been configured to associate optical discriminator 150 (used by viewer 1 151) to source 110 by way of accessing allocated buffer 210, which stores the video data stream received through audio/video input 120. Similarly, port 190 has been configured to associate optical discriminator 155 (used by viewer 2 156) to source 115 by way of accessing allocated buffer 215, which stores the video data stream received through audio/video input 125.

Video data streams stored in allocated buffers 210 and 215 within frame memory buffer 135 are displayed by audio/video output 140 which may display interleaved video data stream 300 one frame at a time on display screen 170. As frames are displayed, transmitter/receiver 145 synchronously sends blanking channel signals 160 as well as audio signals 165 to optical discriminators 150 and 155 through ports 185 and 190 respectively, depending on the frame displayed. For example, when frame “A1” of source 110 is displayed within video data stream 300, transmitter/receiver 145 sends a blanking channel signal 160 to optical discriminator 155 to obstruct the view of the viewer using optical discriminator 155, thereby permitting only the viewer using optical discriminator 150 to view displayed frame “A1”. Furthermore, audio signals 165 corresponding to frame “A1” are contemporaneously sent to optical discriminator 150 to enable a viewer using optical discriminator 150 to hear audio associated with the displayed frame “A1” through an audio listening device accompanying optical discriminator 150.

FIG. 3A additionally provides an exemplary depiction of the various perspectives of viewers within an embodiment of the present invention. Viewers using optical discriminators 150 and 155 are selectively presented with a full screen display of frames from interleaved video data stream 300. Based on the configurations of port 185 and 190, each viewer may only view the frames of each optical discriminators associated source. For example, a viewer using optical discriminator 150 would only be able to view frames “A1”, “A2” and “A3” and prevented from viewing frames “B1”, “B2” and “B3”. The obstructed views of each viewer are depicted as shaded boxes. Each time “B1”, “B2” or “B3” is displayed on display screen 170, transmitter/receiver 145 sends a blanking channel signal 160 to optical discriminator 150 to prevent the viewer from viewing the frame displayed on display screen 170. Furthermore, audio signals corresponding to frames “A1”, “A2” and “A3” are sent to optical discriminator 150. Video data stream 310 represents the subset of frames (frames that are not shaded) from interleaved video data stream 300 that optical discriminator 150 is able to view.

Similarly, a viewer using optical discriminator 155 would only be able to view frames “B1”, “B2” and “B3” and prevented from viewing frames “A1”, “A2” and “A3”. Each time “A1”, “A2” or “A3” is displayed on display screen 170, transmitter/receiver 145 sends a blanking channel signal 160 to optical discriminator 155 to prevent the viewer from viewing the frame displayed on display screen 170. Furthermore, audio signals corresponding to frames “B1”, “B2” and “B3” are sent to optical discriminator 155. Video data stream 305 represents the subset of frames (frames that are not shaded) from interleaved video data stream 300 that optical discriminator 155 is able to view.

FIG. 3B provides another exemplary depiction of an embodiment of the present invention, in which two viewers view two separate video data streams, while two other viewers view the same video data stream. An additional source 220 is provided along with sources 110 and 115. In addition to the port configurations discussed in FIG. 3A, port 195 has been configured to associate optical discriminator 230 (used by viewer 3 231) to source 220 by way of accessing allocated buffer 240. Also, port 200 has been configured to associate optical discriminator 235 (used by viewer 4 236) to source 110 by way of accessing allocated buffer 210.

The video data streams stored in allocated buffers 210, 215 and 240 are displayed by audio/video output 140 as interleaved video data stream 325, which is displayed one frame at a time on display screen 170. As frames are displayed, transmitter/receiver 145 synchronously sends blanking channel signals 160 as well as audio signals 165 to optical discriminators 150, 155, 230 and 235 through ports 185, 190, 195 and 200 respectively, depending on the frame displayed. For example, when frame “A1” of source 110 is displayed, transmitter/receiver 145 sends a blanking channel signal 160 to optical discriminators 155 and 230 to obstruct the view of the viewers using those optical discriminators, thereby allowing only viewers using optical discriminators 150 and 235 to view displayed frame “A1”. Furthermore, audio signals 165 corresponding to frame “A1” are contemporaneously sent to optical discriminators 150 and 235 to enable viewers using those optical discriminators to hear audio associated with the displayed frame “A1” through an audio listening device accompanying those optical discriminators.

FIG. 3B additionally provides an exemplary depiction of the various perspectives of viewers within an embodiment of the present invention. Viewers using optical discriminators 150, 155, 230 and 235 are selectively presented with a full screen display of frames from interleaved video data stream 325 on display screen 170. Based on the configurations of port 185, 190, 195 and 200, each viewer may only view the frames of each optical discriminators' associated source. For example, a viewer using optical discriminator 230 would only be able to view frames “C1”, “C2” and “C3” and prevented from viewing frames “A1”, “A2”, “A3”, “B1”, “B2” and “B3”. The obstructed views of each viewer are depicted as shaded boxes. Each time “C1”, “C2” or “C3” is displayed on display screen 170, transmitter/receiver 145 sends a blanking channel signal 160 to optical discriminators 150, 155, and 235 to prevent the viewers from viewing the frame displayed on display screen 170. Video data stream 315 represents the subset of frames (frames that are not shaded) from interleaved video data stream 325 that optical discriminator 230 is able to view.

Similar to a viewer using optical discriminator 150, a viewer using optical discriminator 235 would also only be able to view frames “A1”, “A2” and “A3” and prevented from viewing frames “B1”, “B2”, “B3”, “C1”, “C2” and “C3”. Each time “A1”, “A2” or “A3” is displayed on display screen 170, transmitter/receiver 145 sends a blanking channel signal 160 to optical discriminators 155 and 230 to prevent the viewer from viewing the frame displayed on display screen 170. Video data stream 320 represents the subset of frames (frames that are not shaded) from interleaved video data stream 325 that optical discriminator 235 is able to view.

FIG. 3C additionally provides yet another exemplary depiction of the various perspectives of viewers within an embodiment of the present invention for 3D viewing. Viewers using optical discriminators 150 (used by Viewer 1 151) and 155 (used by Viewer 2 156) are selectively presented with a full screen display of 3D video frames from interleaved video data stream 325. Upon recognition of the 3D video data stream, embodiments of the present invention may be configured to detect attributes of the display screen and calibrate the synchronization process to account for the additional synchronization of each lens of the optical discriminators along with the synchronization process described herein for each of the optical discriminators utilized.

For example, viewer 151 using optical discriminator 150 would only be able to view frames “A1L”, “A1R”, “A2L”, “A2R” and prevented from viewing frames “B1L”, “B1R”, “B2L”, “B2R”. Furthermore, viewer 151 using optical discriminator 150 would receive frames intended specifically for either the left or right eye. For example, when frame “A1L” is displayed on display screen 170, transmitter/receiver 145 sends a blanking channel signal 160 to the right lens of optical discriminator 150 to prevent the right eye of the viewer from viewing the frame displayed on display screen 170. Similarly, when frame “A1R” is displayed on display screen 170, transmitter/receiver 145 sends a blanking channel signal 160 to the left lens of optical discriminator 150 to prevent the left eye of the viewer from viewing the frame displayed on display screen 170.

Furthermore, when frame “B1L” is displayed on display screen 170, transmitter/receiver 145 sends a blanking channel signal 160 to the right lens of optical discriminator 150 to prevent the right eye of the viewer from viewing the frame displayed on display screen 170. Similarly, when frame “B1R” is displayed on display screen 170, transmitter/receiver 145 sends a blanking channel signal 160 to the left lens of optical discriminator 150 to prevent the left eye of the viewer from viewing the frame displayed on display screen 170. Video data stream 310 represents the subset of frames (frames that are not shaded) from interleaved video data stream 325 that optical discriminator 150 is able to view. Video data stream 305 represents the subset of frames (frames that are not shaded) from interleaved video data stream 325 that optical discriminator 155 is able to view.

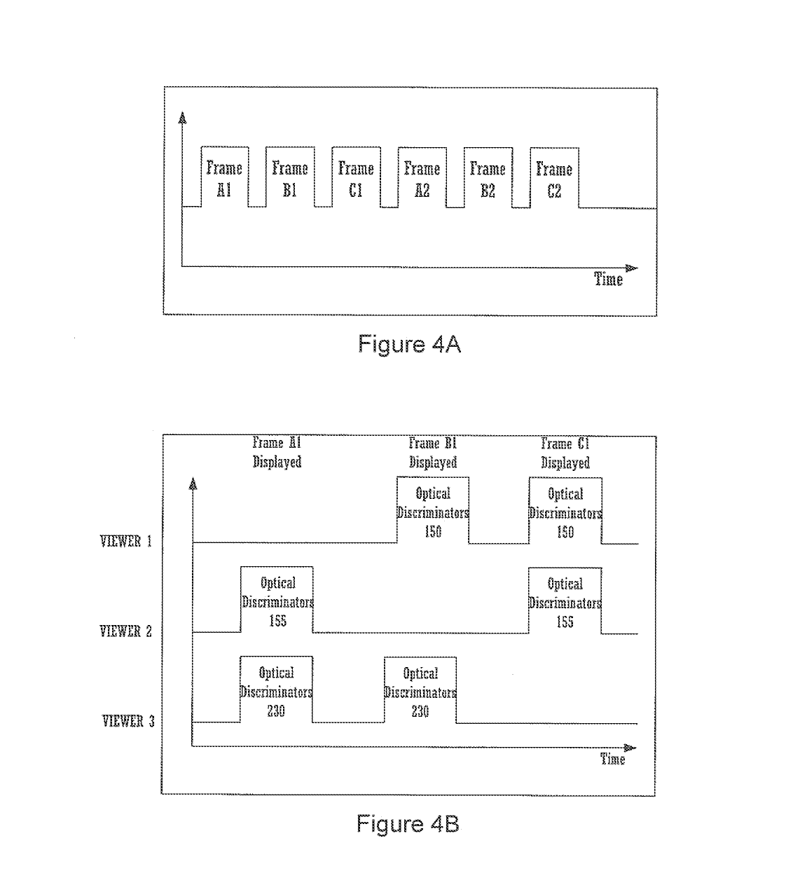

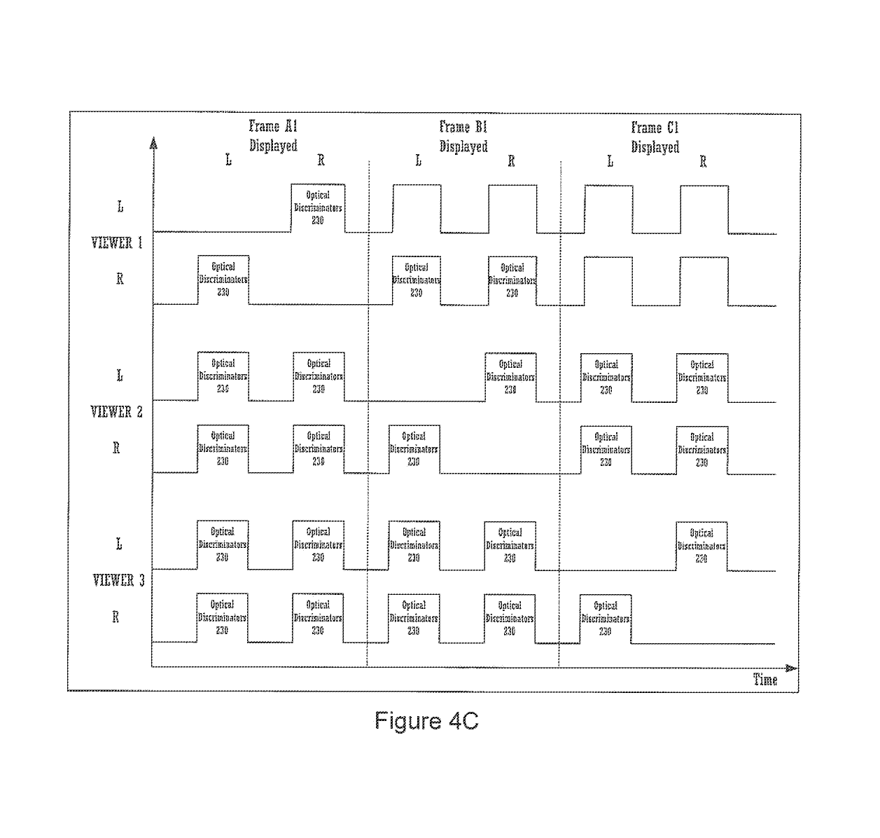

FIG. 4A depicts a timing diagram illustrating how frames are display on display screen 170 in accordance with the various embodiments herein described. For example, using the configuration described in FIG. 3B, frames from each of the video data streams stored in allocated buffers 210, 215 and 240 may be displayed one frame at a time, in a round-robin sequence. For example, in one exemplary sequence, frame “A1” from allocated buffer 210 may be displayed first, followed by frame “B1” from allocated buffer 215 and, then, frame “C1” from allocated buffer 240, etc.

FIG. 4B depicts a timing diagram which illustrates of how blanking channel signals 160 may be sent from transmitter/receiver 145 to optical discriminators 150, 155 and 230 in accordance with the various embodiments herein described. When frame “A1” is displayed, transmitter/receiver 145 simultaneously sends blanking channel signals 160 to optical discriminators 155 and 230, while optical discriminator 150 are able to view the displayed frame. When frame “B1” is displayed, transmitter/receiver 145 simultaneously sends blanking channel signals 160 to optical discriminator 150 and 230, while optical discriminator 155 are able to view the displayed frame. Furthermore, when frame “C1” is displayed, transmitter/receiver 145 simultaneously sends blanking channel signals 160 to optical discriminators 150 and 155, while optical discriminator 230 are able to view the displayed frame. It is appreciated that in lieu of blanking channel signals, the embodiments of the present invention may also utilize unblanking signals in vice-versa fashion.

FIG. 4C depicts a timing diagram which illustrates of how blanking channel signals 160 may be sent from transmitter/receiver 145 to optical discriminators 150, 155 and 230 during the display of 3D video data in accordance with the various embodiments herein described. When a frame is displayed, transmitter/receiver 145 sends blanking channel signals 160 to optical discriminators 150, 155 and 230 in the manner described in FIG. 4B and additionally sends blanking channel signals 160 to each lens of the optical discriminator that is able to view the frame to enable a viewer to perceive the desired 3D effect. For example, when frame “A1L” is displayed, transmitter/receiver 145 sends blanking channel signals 160 to optical discriminators 155 and 230 and to the right lens of optical discriminator 150. Similarly, when frame “A1R” is displayed, transmitter/receiver 145 sends blanking channel signals to optical discriminators 155 and 230 and to the left lens of optical discriminator 150. In this example, these additional blanking signals sent to either left of right lens of the optical discriminators enable the viewer to perceive the desired 3D effect. It is appreciated that in lieu of blanking channel signals, the embodiments of the present invention may also utilize unblanking signals in vice-versa fashion.

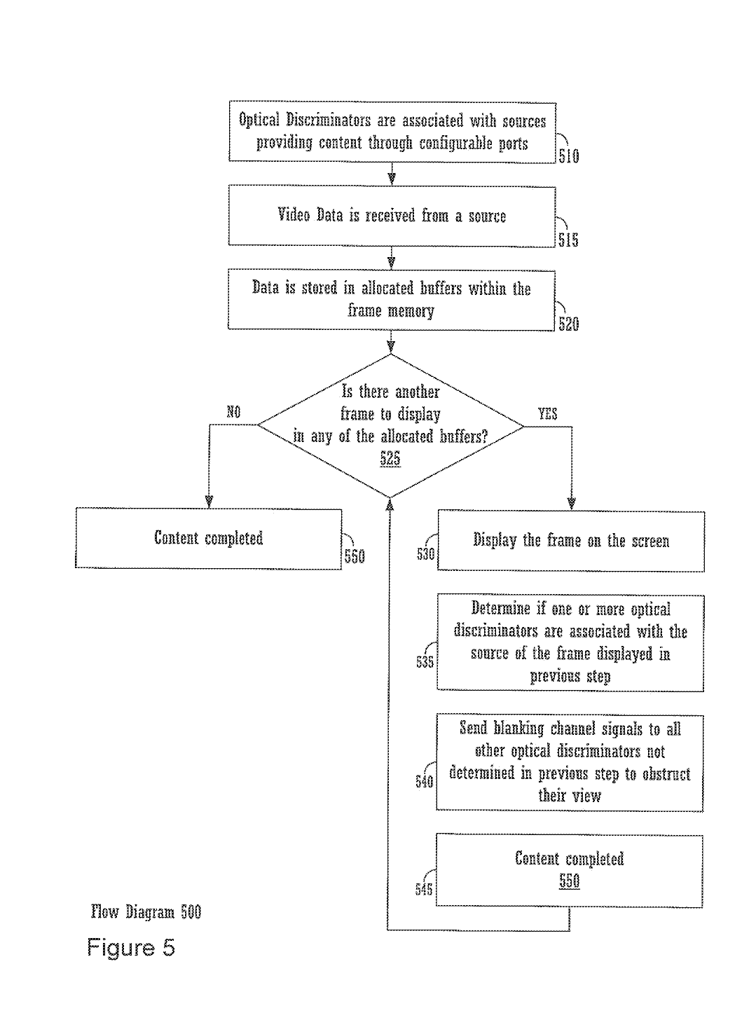

FIG. 5 is a flowchart which describes exemplary steps in accordance with the various embodiments herein described.

At step 510, optical discriminators are associated with sources providing content through configurable ports. A viewer wishing to view a particular content may use optical discriminators that are associated to a port that is configured to display the desired content.

At step 515, video data is received from a source, (e.g. a DVD player, video game console, live television feed, etc.) through an audio/video input. The source may be representative of any electronic device capable of producing audio/video content. The data may be sourced from either a single source capable of providing multiple video data streams or multiple sources providing multiple video data streams.

At step 520, the data is stored in allocated buffers within the frame memory buffer. The processor of the controller accesses the video data streams from the audio/video inputs and stores the data in allocated buffers within frame memory buffer. Using an application residing in memory, the processor stores video data streams into separate allocated buffers within the frame memory.

At step 525, a determination is made as to whether there is another frame to be displayed from any of the allocated buffers from step 520. If there is, the process flow proceeds to step 530 for display, otherwise, the process flow proceeds to step 550, in which the content is completed.

At step 530, the frames stored within the allocated buffers are displayed on the display screen, one frame at time.

At step 535, an embodiment of the present invention determines if one or more optical discriminators are associated with the source of the frame that is displayed in step 530.

At step 540, the transmitter/receiver sends blanking channel signals to all optical discriminators not determined in step 535 to prevent them from viewing the displayed frame at step 530.

At step 545, the transmitter/receiver sends audio signals, associated with frame displayed at step 530, to all optical discriminators determined in step 535.

At step 550, no more frames are available to be displayed.

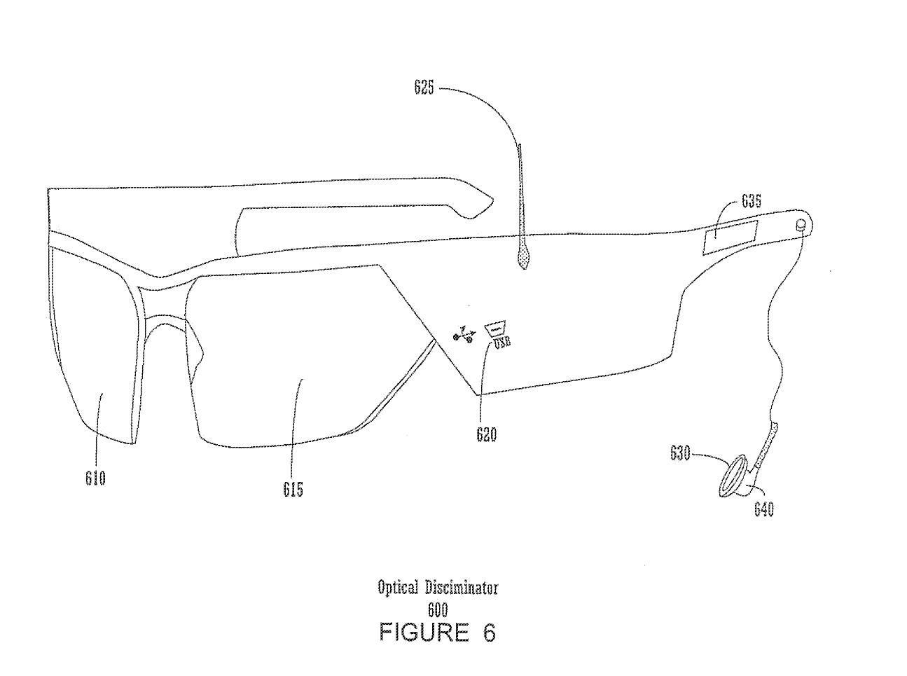

FIG. 6 is an exemplary depiction of an optical discriminator used in accordance with embodiments of the present invention. The optical discriminator may utilize either active of passive 3D technology for 3D video data. Optical discriminators may utilize existing active shutter 3D system technology in which both the left lens 615 and right lens 610 of an optical discriminator 600 are synchronized to selectively darken to block out light and prevent the viewer from viewing frames displayed on a display screen not associated with the discriminator. Synchronization may occur though either a wired or wireless connection. A USB port 620 located on the frames of the optical discriminator may allow synchronization requiring a wired connection. Alternatively, an antenna 625 located on the frames facilitate wireless synchronization. In addition, optical discriminator may be coupled with an audio receiver 635 and rendering device 640 which enables a viewer to use ear buds 630 to receive and render audio corresponding with the video content received.

Current active shutter 3D technology enables an individual to view 3D images. The technology uses a process which presents images intended for one eye by blocking the other eye and then alternating the presentation using a different image intended for the previously unblocked eye. For example, images to be viewed by the left eye are presented by blocking the right eye, which is then followed by presenting images to the right eye by blocking the left eye. This form of display makes use of liquid crystal shutter glass lenses that may be instructed to darken through signals (e.g. infrared signals, radio frequency signals, Bluetooth, optical transmitter signals, etc.) and manipulate the brain of an individual into perceiving that the images displayed are 3 dimensional.

Embodiments of the present invention achieve a similar effect on viewers using optical discriminator 600. Upon recognition of the 3D video data stream, embodiments of the present invention may be configured to detect attributes of the display screen and calibrate the synchronization process to account for the additional synchronization of each lens of the optical discriminators along with the synchronization process described herein for each of the optical discriminators utilized.

1. A display method of allowing a plurality of viewers to view different content displayed on a single display screen, said method comprising:
associating subsets from a plurality of frames of content to respective different viewers of said plurality of viewers to produce a plurality of associated viewer sets;
storing said associated viewer sets in a memory buffer;
displaying said associated viewer sets on said single display screen in full screen mode, wherein each viewer has associated therewith a respective optical discriminator of a plurality of optical discriminators; and
synchronizing each optical discriminator with said displaying, wherein said synchronizing allows each viewer of said plurality of viewers to perceive only an associated viewer set on said single display screen.

2. The display method described in claim 1, wherein said content is video data.

3. The display method described in claim 1, wherein said content is 3D video data.

4. The display method described in claim 1, wherein each optical discriminator is coupled with a respective audio receiving device, wherein further said respective audio receiving device receives audio associated with an associated viewer set.

5. The display method described in claim 1, wherein said synchronizing further comprises:
detecting display attributes of said display screen;
detecting a number of optical discriminators, of said plurality of optical discriminators;
determining a synchronization rate based said display attributes and said number of optical discriminators; and
transmitting a periodic synchronization signal based on said synchronization rate for each optical discriminator of said plurality of optical discriminators.

6. The display method described in claim 1, wherein said plurality of optical discriminators are communicatively coupled to said display screen through a wired connection.

7. The display method described in claim 1, wherein said plurality of optical discriminators are communicatively coupled to said display screen through a wireless connection.

8. The display method described in claim 1, wherein said plurality of optical discriminators incorporate active shutter 3D system technology.

9. A display method of allowing a plurality of viewers to view different content displayed on a single display screen, said method comprising:
identifying a plurality of frames of content from a grouped frame set to produce a plurality of grouped frame subsets;
associating each grouped frame subset from a plurality of grouped frame subsets to a different optical discriminator, of a plurality of optical discriminators, producing a plurality of associated viewer sets;
storing said plurality of associated viewer sets in a memory buffer;
displaying said plurality of associated viewer sets on a single display source in full screen mode; and
synchronizing each optical discriminator of said plurality of optical discriminators with said displaying, wherein said synchronizing allows a respective viewer of an associated optical discriminator to perceive only an associated viewer set on said display screen.

10. The display method described in claim 9, wherein said content is video data.

11. The display method described in claim 9, wherein said content is 3D video data.

12. The display method described in claim 9, wherein each optical discriminator of said plurality of optical discriminators is coupled with a respective audio receiving device, wherein further said respective audio receiving device receives and renders audio associated with an associated specified viewer set.

13. The display method described in claim 9, wherein said synchronizing further comprises:
detecting display attributes of said display screen;
detecting a number of optical discriminators, of said plurality of optical discriminators;
determining a synchronization rate based said display attributes and said number of optical discriminators; and
transmitting a periodic synchronization signal based on said synchronization rate for each optical discriminator of said plurality of optical discriminators.

14. The display method described in claim 9, wherein said plurality of optical discriminators are communicatively coupled to said display screen through a wired connection.

15. The display method described in claim 9, wherein said plurality of said optical discriminators are communicatively coupled to said display screen through a wireless connection.

16. The display method described in claim 9, wherein said plurality of said optical discriminators incorporate active shutter 3D system technology.

17. A display system comprising:
(a) a controller operable to communicate with a plurality of optical discriminators and a display screen system, said controller comprising:
an associating module for associating subsets from a plurality of frames of content to respective different viewers of a plurality of viewers to produce a plurality of associated viewer sets, wherein each viewer has associated therewith a respective optical discriminator of said plurality of optical discriminators; and
a storage module for storing said plurality of associated viewer sets in a memory buffer;
a synchronization module generating synchronization signals for synchronizing each optical discriminator with said display system, wherein said synchronizing allows each viewer to perceive only an associated viewer set on a single display screen; and
(b) said display screen system comprising:
said single display screen; and
a displaying module for displaying said plurality of specified viewer sets on said single display screen in full screen mode.

18. The display system described in claim 17, wherein said plurality of optical discriminators are communicatively coupled to said controller through a wired connection.

19. The display system described in claim 17, wherein said plurality of optical discriminators are communicatively coupled to said controller through a wireless connection.

20. The display system described in claim 17, wherein said plurality of optical discriminators incorporate active shutter 3D system technology.

21. The display system described in claim 17, wherein said controller is external to said display screen system.

22. The display system described in claim 17, wherein said controller is embedded in said display screen system.
